(19) United States
(12) Patent Application Publication
(10) Pub. No.: US 2026/0174268 A1
(43) Pub. Date: Jun. 25, 2026

(54) MANUAL COFFEE PRESS ASSEMBLY AND METHOD OF MAKING COFFEE USING SAME

(71) Applicant: Optex Solar Pty Ltd, Port Melbourne (Victoria) (AU)

(72) Inventor: Gregory GROCHOLA, Port Melbourne (Victoria) (AU)

(73) Assignee: Optex Solar Pty Ltd, Port Melbourne (Victoria) (AU)

(21) Appl. No.: 19/126,282

(22) PCT Filed: Nov. 6, 2023
(86) PCT No.: PCT/AU2023/051119

§ 371 Date: May 1, 2025

(30) Foreign Application Priority Data
Nov. 7, 2022 (AU) 2022903318

(51) Int. Cl. A47J 31/36; A23F 5/26

(52) U.S. Cl. CPC A47J 31/36; A23F 5/262; A47J 31/3609; A47J 31/3614; A47J 31/3671

(57) ABSTRACT

A manual coffee press assembly comprising: a hollow cylindrical chamber having a top opening via which water for brewing coffee can be poured into the chamber; a basket having a perforated base onto which ground coffee beans can be loaded and tamped, wherein in use, the basket containing the tamped ground coffee beans is inverted and removably secured to the chamber to close the top opening thereof so that the ground coffee beans are held above water in the chamber; a piston which, in use, forms an air-tight seal with the chamber so as to be drivable upwardly therethrough to force the water therein through the ground coffee beans in the basket so as to exit through the perforated base thereof as coffee; and a collector from which the coffee exiting the perforated base can be dispensed.

### FIELD OF THE INVENTION

Disclosed herein are a manual coffee press assembly and an associated method of making coffee using said coffee press assembly.

### BACKGROUND

Coffee is one of the most consumed beverages worldwide. Various extraction means and methods exist to extract soluble components from coffee grounds (a powdered form of coffee beans created by grinding roasted coffee beans finely). It is well known that various combinations of soluble components can be extracted depending on the exact extraction means and methods. Said combinations form distinct and desired taste profiles in coffee drinks. One method with a particularly desirable and popular taste profile is termed espresso, and it involves forcing hot water at high pressure through a compacted cylinder of coffee grounds, termed a puck, at 5-12 bar water pressure.

Typically, the means to do this involves a mains-powered espresso machine, which includes a water supply, a heater, a pump, and facilities to hold the coffee grounds in place while forcing hot water evenly through said grounds. Alternatively, espresso can also be extracted using various hand-operated espresso machines, which use various mechanical leverage means to generate the 5-12 bars of water pressure required to force water through the coffee grounds.

Hand-operated machines are cheaper, simpler, more reliable, and more portable than mains-powered machines. However, some existing hand-operated machines that are known and used today are some combination of—not ergonomic to use, and/or are mechanically complex, difficult to maintain and/or service, and/or require extensive preheating, and/or have limited portability and a large kitchen footprint, and/or are not easy and/or fast to clean and/or operate and/or have issues with uneven extraction which is commonly encountered in espresso production.

One specific well-known issue termed channelling is where water does not evenly move through said coffee puck for a variety of reasons; instead, the water finds a way to bypass parts of the grounds through narrow water channels without extracting some parts of the grounds while over-extracting other parts, specifically in the area experiencing the bulk of the water flow. This results in watery-tasting espresso.

There is a need to address the above, and/or at least provide a useful alternative.

### SUMMARY

According to a first aspect of the present invention, there is provided a manual coffee press assembly comprising:
a hollow cylindrical chamber having a top opening via which water for brewing coffee can be poured into the chamber;
a basket having a perforated base onto which ground coffee beans can be loaded and tamped, wherein in use, the basket containing the tamped ground coffee beans is inverted and removably secured to the chamber to close the top opening thereof so that the ground coffee beans are held above water in the chamber;
a piston which, in use, forms an air-tight seal with the chamber so as to be drivable upwardly therethrough to force the water therein through the ground coffee beans in the basket so as to exit through the perforated base thereof as coffee; and
a collector from which the coffee exiting the perforated base can be dispensed.

In certain embodiments, the assembly further comprises a retaining disc securable to the basket for, in use, containing the tamped ground coffee beans in the inverted basket.

Preferably, the assembly also comprises at least one lever that is manually operable in a first direction to drive the piston upwardly through the chamber. The at least one lever may also be manually operable in a second direction to drive the piston downwardly through the chamber. Driving the piston downwardly may help drain any water remaining in the chamber, and may also assist with at least partially dislodging the tamped ground coffee beans for easier extraction out of the basket for disposal.

It is envisaged that the assembly may also comprise a base from which the chamber extends upwardly, the base having locating means for guiding manual operation of the lever in the first and second directions.

In certain embodiments, the collector comprises a cylindrical wall surrounding and extending above the perforated base of the basket for capturing the coffee that exits therethrough.

Embodiments of the assembly may also comprise a cover securable over the collector to contain coffee therein.

According to a second aspect of the present invention, there is provided a method of making coffee using a manual coffee press assembly according to a first aspect of the present invention, comprising:
loading and tamping ground coffee beans into the basket;
pouring water into the chamber via the top opening thereof;
inverting the loaded basket and securing it to the chamber so as to close the top end thereof; and
driving the piston upwardly through the chamber to force the water upwardly through the ground coffee beans and out the perforated base of the basket as coffee for dispensing from the collector.

### BRIEF DESCRIPTION OF THE DRAWINGS

Various embodiments of the invention will now be described, by way of example only, with reference to the accompanying drawings in which:

FIG. 1 is a top perspective view of a manual coffee press assembly according to embodiments of the present invention, shown in an assembled state and prior to driving of a manually operable piston within a cylindrical water chamber of the assembly;

FIG. 2 is a close-up front cross-sectional view of an interface between the water chamber, inverted basket and collector of the assembly of FIG. 1;

FIGS. 3(a) to 3(l) each show a close-up cross-sectional front view of an interface between a water chamber, inverted basket and collector of embodiments of the present assembly, the Figures showing various locking and/or sealing mechanisms at the interface;

FIG. 4 is a top perspective view of the assembly of FIG. 1 with the inverted basket and collector removed and the piston driven upwardly through the water chamber via manual operation of levers of the assembly;

FIG. 5 shows a top perspective view of the piston of the assembly of FIG. 1 and its movement as manually operated by associated levers;

FIG. 6 is a side perspective view of an alternate collector embodiment that may be used with manual coffee press assemblies according to embodiments of the present invention;

FIG. 7 is a top perspective view of a second embodiment of a manual coffee press assembly in an assembled state and prior to driving of a piston thereof to extract coffee;

FIGS. 8(a) to 8(h) show cross-sectional schematic side views of various embodiments of the present assembly having different lever mechanisms;

FIG. 9 is a side perspective view of a retaining disc configured to retain the ground coffee beans in the inverted basket of a manual coffee press assembly according to embodiments of the present invention;

FIG. 10 is a side perspective view of a cover for closing the collector of a manual coffee press assembly according to embodiments of the present invention;

FIG. 11 is an exploded perspective view of a manual coffee press assembly according to embodiments of the present invention;

FIG. 12 shows a cross sectional view of a transport retainer assembly for use with a basket of the present assembly to lock in and retain the coffee grounds during transport; and

FIG. 13 shows a perspective view of the underside of a locking section of embodiments of the present assembly with locking structures matching those of the chamber shown in FIG. 4.

### DETAILED DESCRIPTION

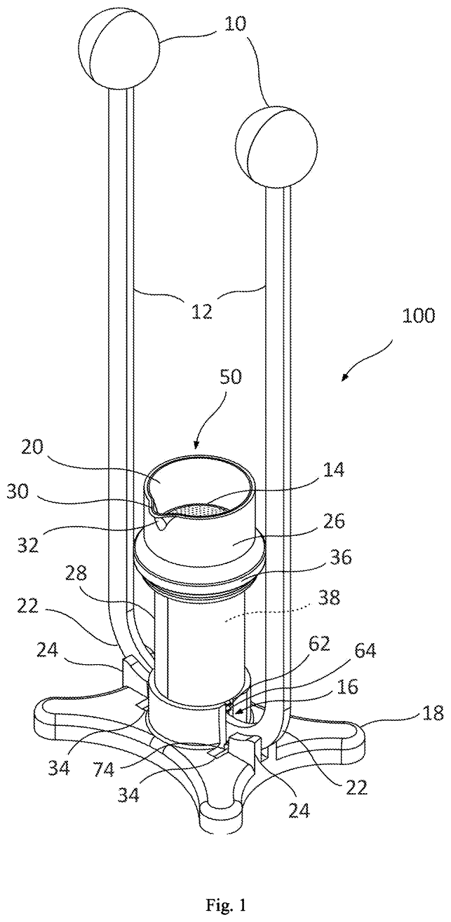

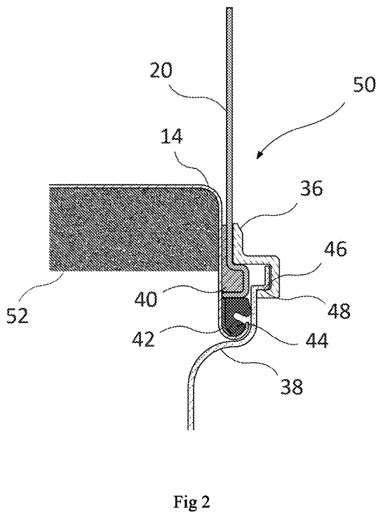

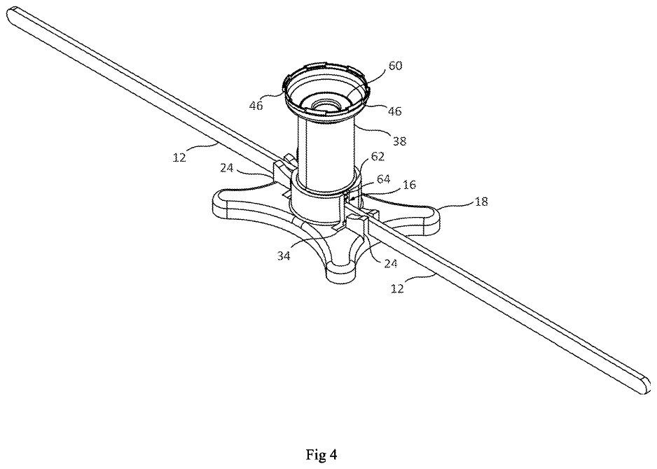

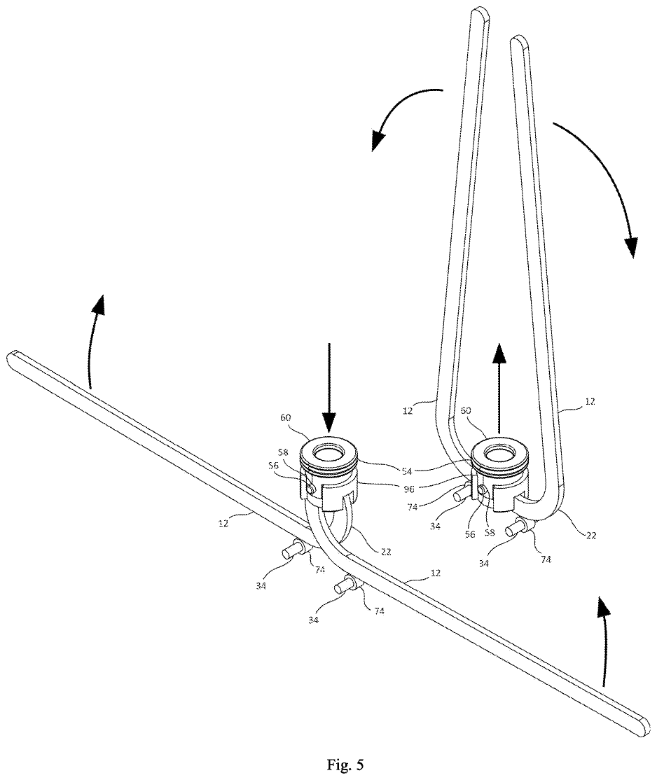

FIG. 1 shows a manual coffee press assembly 100 according to embodiments of the present invention. The press 100 is shown in an assembled state and generally comprises:
a base 18;
a hollow cylindrical chamber 38 extending upwardly from the base 18 into which water can be poured;
a basket (also see FIG. 2) with a perforated base 14 which is shown in an inverted orientation and is configured to contain the ground coffee beans 52 from which coffee is to be extracted;
a collector 20 extending above the basket 14 from which extracted coffee exiting through the perforated base of the basket 14 can be dispensed; and
a hand-actuated piston 60 (see FIGS. 4 and 5) within the chamber 38 which is manually drivable upwardly therethrough to force water in the chamber 38 through the ground coffee puck 52 in the basket 14 thereabove so as to exit as coffee through the perforated base of the basket 14 for dispensing from the collector 20. In other words, coffee is extracted by forcing water upwardly, under pressure, through the coffee puck 52 retained in the inverted basket 14. The positive pressure inside the chamber 38 generated by the piston 60 driven upwardly therein inhibits the extracted coffee from returning back through the perforations of the basket 14. The assembly 100 may comprise one or more hand-operated levers 12 associated with the piston 60 to effect driving thereof within the chamber 38.

Prior art espresso machines and presses typically utilise a top-to-bottom water flow, wherein water flows downwardly through the tamped ground coffee beans (also referred to herein as a coffee puck). However, gravity causes the water to flow unevenly, causing uneven water seepage and saturation of the coffee puck's surface; this uneven pre-wetting of the puck can cause uneven extraction. The importance of achieving even distribution and flow of water onto the puck's surface and through the puck is highlighted by the fact that espresso machine manufacturers provide water distribution devices (known as shower screens) that attempt to achieve a more even “showering” of water onto the top coffee grounds in the portafilter basket.

In contrast, the present manual coffee press assembly utilises a bottom-to-top water flow, wherein water is forced upwardly against gravity through the coffee puck in the inverted basket. This opposite orientation and water flow direction allow for a level surface of water to flood the puck's surface evenly, thereby creating an even initial wetting and extraction of coffee and thus obviating complex shower screen devices.

Furthermore, it is well known that an evenly prepared puck of coffee grounds in a portafilter basket is critical to an even extraction, and viewing of a perforated base of that basket during extraction helps in diagnosing any extraction issues. Since the basket and perforated base thereof of the present assembly are inverted during extraction, the basket perforations can be easily viewed by the user without the use of a reflective surface typically used with other machines, making it easy to evaluate the evenness of the extraction process and hence diagnose any issues with how the barista prepared, distributed, and tamped the coffee grounds.

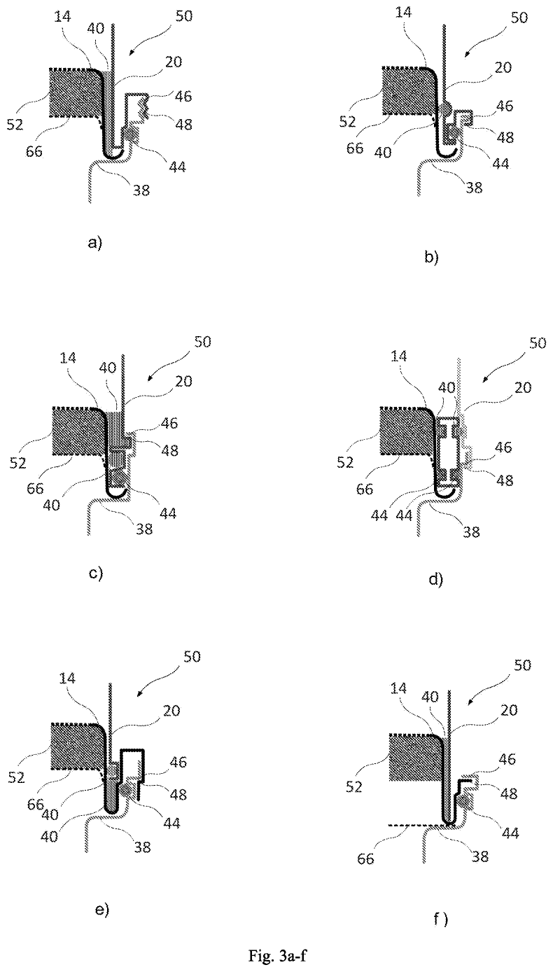

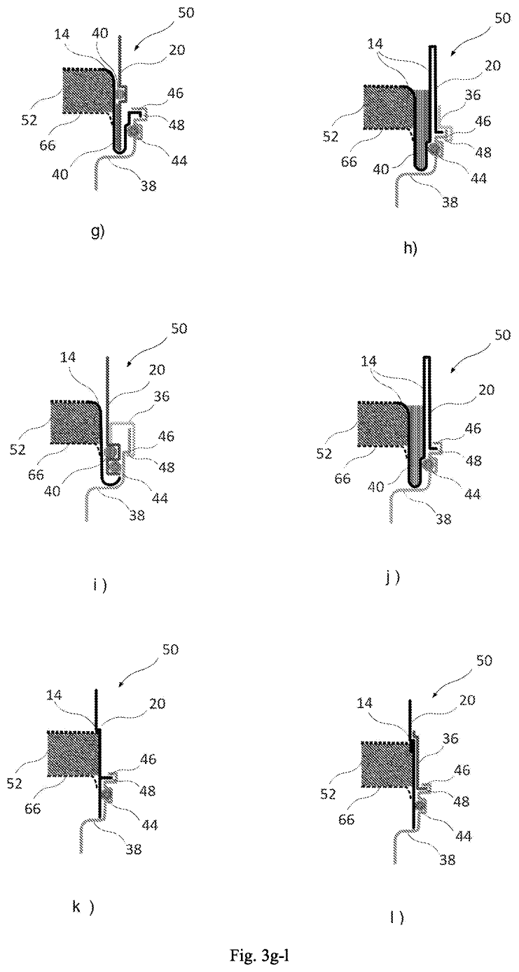

In embodiments of the present assembly 100, the basket 14 may comprise a standard espresso portafilter basket. For example, with reference to FIG. 2, the basket 14 may be formed from a hollow cylindrical container with a perforated base. Also shown in FIG. 2 is the collector 20 and a separate locking section 36 which facilitates releasable securement of the basket 14 and collector 20 to the chamber 38. Of course, other means and engagement mechanisms for achieving such releasable securement to the chamber 38 are within the scope of the present specification, and certain examples are illustrated in FIGS. 3(a) to 3(l), as will be discussed.

Referring to the embodiment of FIG. 2, in use, the separate locking section 36 can be hand-operated (e.g., twisted) to release the basket 14 and collector 20 from the chamber 38. The basket is then flipped upside down such that the perforated base thereof faces downwards so that the basket 14 is not inverted. Ground coffee beans 52 can then be loaded into the basket 14 and tamped. While the basket 14 and collector 20 are disconnected from the water chamber 38, hot water can be poured therein through the top opening thereof. The basket 14 and collector 20 can then be inverted and secured to close the top opening, as shown in FIG. 2, ready for extraction.

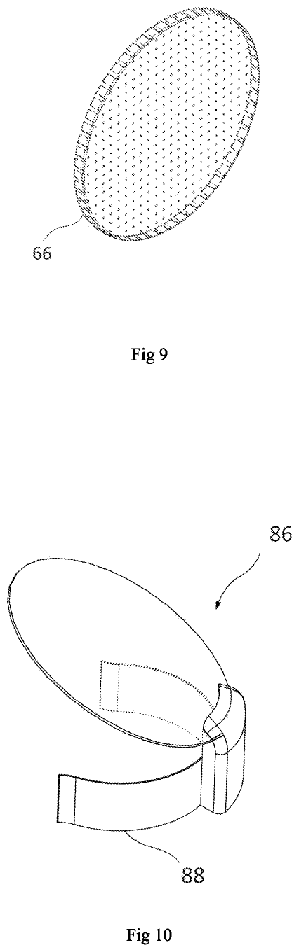

Preferably, the prepared coffee puck 52 within the basket 14 is well-tamped and will not fall out of the inverted basket 14. However, optionally, and to aid clean-up, a retaining disc 66 can be secured to and/or inside the basket 14 and over the coffee puck 52 after tamping to prevent the puck 52 from falling out of the inverted basket 14. For example, the disc 66 may be positioned between the chamber 38 and basket 14. The retaining disc 66 may comprise a substantially flat perforated plate with bent side tabs (see FIGS. 3 and 9) and/or an outer elastic seal to create a radially flexible interference edge with the inner cylindrical wall of the basket 14.

In an alternative embodiment, the retaining disc 66 may be positioned as shown in FIG. 3(f), wherein said disc 66 is formed as a substantially flat perforated disk that covers the top opening of the water chamber 38. After extraction, the used coffee puck 52 can be sucked out (as will be discussed) to rest on the retaining disc 66, preventing it from falling inside the chamber 38. This is to aid clean-up and disposal of the puck 52.

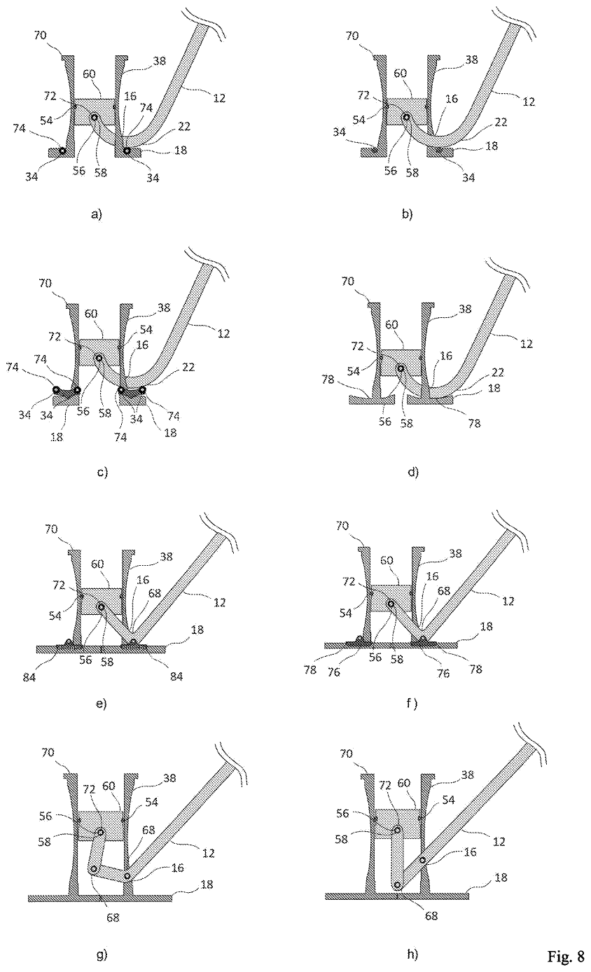

FIGS. 5 and 8(a) to 8(h) illustrate a working principle underlying a manual coffee press assembly 100 according to embodiments of the present invention. The assembly 100 comprises a hollow cylindrical chamber 38 having a top opening via which water for brewing coffee can be poured into the chamber 38. The chamber may be integrally formed with the base 18. A piston 60 is arranged within the chamber 38 and forms an air-tight seal with the internal cylindrical wall of the chamber 38. The piston 60 can be manually driven upwardly through the hollow of the chamber 38 to force water out the top opening thereof. The piston 60 may also be manually driven downwardly through the hollow of the chamber 38 so as to generate a negative pressure within the chamber 38 which assists with drawing the used coffee puck out 52 of the inverted basket 14 for disposal.

In use, and prior to extraction, the piston 60 is moved to a lowered position within the chamber 38 so that there is sufficient volume therewithin to receive water. The water poured into the chamber 38 would sit on the head of the piston 60 and would not flow therepast given the seal between the piston 60 and the internal cylindrical wall of the chamber 38. The inverted basket 14 with the tamped coffee grounds 52 can then be secured over the top opening of the chamber 38, ready for extraction. The piston 60 can then be driven upwardly through the chamber 38, thereby forcing the water upwards so that it evenly wets and passes through the coffee puck 52 and out the perforated base of the basket 14 for dispensing from the collector 20.

With reference to FIG. 5, the piston 60 may have an elastomeric sealing portion 54 which forms the air-tight seal with the internal cylindrical wall of the water chamber 38. In the depicted embodiments, the piston 60 is operably associated with one or more manually operable levers 12. For example, with reference to FIG. 5, the levers 12 may be grasped and urged open and downwardly in a first direction to drive the piston 60 upwardly within the water chamber 38. After coffee extraction, the levers 12 may be urged upwardly and together in a second direction to drive the piston 60 downwardly within the water chamber 38.

In the depicted embodiments, the or each lever may be in the form of a generally elongate arm 12 operably associated with the piston 60. For example, in FIG. 1, each arm 12 comprises an elongate portion terminating in a graspable handle 10, the arms 12 extending generally vertically upwardly on either side of the water chamber 38. Referring also to FIGS. 1 and 5, each arm 12 also comprises a curved lower portion 22 which may extend through respective side slots or ports 16 of the base 18 and/or the water chamber 38, the ends of each curved lower portion 22 being pivotably associated with a lower end or portion of the piston 60. The curved lower portion 22 may be located by and/or on laterally disposed guides 24 of the base 18 into the chamber 38. FIG. 5 also shows the use of roller bearings/bushings 74 along which the arms 12 can move when operated. In use, starting with the arms 12 upright, a user can grab the respective handles 10 and urge each arm 12 away from one another and downwardly such that the elongate arm portions 12 extend laterally outwardly while the curved lower portion 22 enter further into the chamber 38 and rise upwardly therewithin, thereby driving the piston 60 upwardly through the chamber 38. Similarly, the handles 10 can be grasped to raise and close the arms 12 back towards their vertically extending configuration, thereby retracting and lowering the curved lower portion 22 from within the chamber 38 and thus driving the piston 60 downwardly through the chamber 38.

Of course, the working principle underlying how the or each arm 12 drives the piston 60 within the chamber 38 can be implemented in many ways using known means and mechanisms, certain examples of which are shown in FIGS. 8(a) to 8(h). As can be seen, the example arms 12 are pivotably associated with the piston 60 and can utilise curved or straight sections, and utilise various pivotable linkage joints, mounts and the like to achieve the result wherein the arm 12 is manually operable in a first direction to drive the piston 60 upwardly within the chamber 38, and an opposite second direction to drive the piston 60 downwardly within the chamber 38.

With reference to FIGS. 5 and 8, the piston 60 may comprise a through hole 58 where there is inserted a horizontally arranged cylindrical shaft 56. The chamber 38 end of the or each arm 12 has a corresponding through hole 72. Alternative arrangements for pivotal associations between the arm(s) 12 and the piston 60 are of course within the scope of the present specification, and may include, for example, ball and socket mechanisms, or, to connect more than one arm 12, a half ball or flat disk structure at the tip for each arm 12 and matching socket space in the bottom portion of said piston 60. A further structure associated with the piston 60 is the arm locating retainer 96, whose purpose is to retain and centre the or each arm 12 top end portion centrally within the base of the piston 60. This structure and locating function can be incorporated within the piston 60 itself or made as a separate part attached to the piston 60.

As alluded to earlier, the base 18 preferably has one or more arm alignment means, (see FIGS. 1, 4, 7 and 8d) such as one or more grooves or upwardly extending and spaced apart walls 24 between which the arms 12 are located and can move. The base 18 may also comprise one or more lubricated roller bearings/bushings 74, bearing shafts 34, friction slides 76, linear bearing slides 84, bearing grooves 78 and the like for receiving and smoothly guiding the motion of the arms 12 into and out of the chamber 38 for driving the piston 60 therein. The chamber 38 and/or base 18 may have at least one open arm side slot or port 16 through which the or each arm 12 is inserted into the water chamber 38.

In use, the upward driving of the piston 60 forces water within the chamber 38 upwardly into the inverted basket 14 and hence through the coffee puck 52, preferably at a peak pressure of 5-20 bar. The extracted coffee liquid is then expelled upward through the perforated base of the basket 14 in full view of the user. The exiting coffee may be collected in the collector 20 (to be discussed in more detail) and can be dispensed therefrom into a vessel (e.g., mug) by tipping the assembly 100. The collector 20 may comprise a spout 30 with a heat shield cover 32 via which the extracted coffee can be poured.

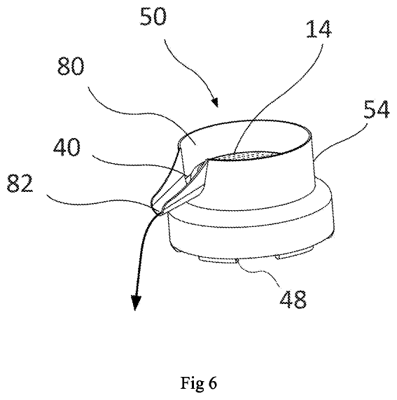

FIG. 6 shows an alternative embodiment wherein instead of the collector 20 and associated spout 30 shown in FIG. 1, we have a diverter comprising a shorter side wall 80 and an associated longer diverter spout 82. In this embodiment, coffee extracted through the perforated base of the basket 14 is directed to simply be dispensed to pool, channel and flow along the longer diverter spout 82 of the diverter, for example, into a mug positioned to the side of the press, without the need for tipping of the press. It is envisaged that the diverter 80, spout 82, and basket 14 could be integrally formed in one piece and the top edge of the side wall diverter 80 need not extend above the basket's 14 perforated base, wherein extracted coffee can pour out of the perforated base and down the side of the basket 14 and pool, channel and flow along the longer diverter spout 82 into a cup for example.

After coffee extraction and pouring, the arm(s) 12 action is reversed to pull the piston 60 downwardly within the chamber 38, preferably creating negative pressure therein which preferably draws the used coffee puck 52 out of the basket 14 (or at least helps to dislodge the puck 52 from the basket 14), onto the retainer 66. This action may also help with the draining of any remaining water, down into the chamber 38. The collector 20 and basket 14 can then be removed and the puck 52 can be disposed of through the top opening of the chamber 38. Components of the assembly 100, including the chamber 38, basket 14 (and collector 20 if formed separately), can then be detached and rinsed clean.

Referring to FIG. 1, the vertically mounted overflow container or collector 20 comprises a cylindrical sidewall that extends around and above the perforated base of the inverted basket 14. In use, the collector 20 functions like a container for the extracted coffee. The collector 20 may be manufactured using a deep-drawn manufacturing method as an extension of the sidewall of the basket 14, as shown in FIGS. 3(h), 3(j), 3(k) and 3(l). In this way, the collector 20 and basket 14 may be integrally formed. Alternatively, the collector 20 may constitute a separate removable component altogether and can be positioned around the basket 14, as shown in FIGS. 3(a) to 3(g) and 3(i), in which case one or more flexible (e.g., elastomeric) overflow seals 40 at an interface of the collector 20 and basket 14 can be provided to prevent inadvertent leakage of extracted coffee therebetween. Shown in FIGS. 3(k) and (l) are examples where the basket 14 with perforated base is manufactured by forming a deep drawn cylindrical part with a narrowed end lip or edge into which a perforated disk can be inserted and then welded (or retained using some other means) inside said cylindrical part, thus forming a more square cross-sectional basket 14.

In use, the basket 14 and chamber 38 (and collector 20 in embodiments where it is removable, and any associated locking and/or sealing means) are releasably locked together and fluidically sealed such that water in the chamber 38 that is driven upward through the coffee puck 52 and inverted basket 14 is substantially collected as coffee in the collector 20 for dispensing therefrom. Various means for removably locking and sealing said assembly components 14, 20, 38 are of course within the scope of the present specification. Examples of different variations are shown throughout the Figures.

For example, the assembly 100 may comprise top retaining surfaces 48, shown in FIGS. 2 and 3, these being substantially upwardly exposed surfaces on an indent, bulge, tab, slit, clip, and or thread integrated into either the basket 14 side wall or into said collector 20 or integrated into a separate locking section 36 as shown in FIGS. 1, FIG. 2, FIG. 3(h) and FIG. 3(i). Meanwhile, an upper end of the water chamber 38 may be provided with corresponding bottom retaining surfaces 46 substantially downwardly exposed on an indent, bulge, tab, slit, clip, and or thread. In use, the bottom retaining surfaces 46 are engaged with the top retaining surfaces 48 to provide one or more overlapping surfaces so as to lock the basket 14 and collector 20 to the chamber 38, preventing them from being displaced vertically therefrom under water pressure during coffee extraction. Various sealing means 40, 44 may be provided to ensure a fluidic seal and may be provided with the basket 14, collector 20 and/or chamber 38. The locking action may include a radial twist of the basket 14, collector 20 and/or separate locking section 36 relative to the chamber 38, thereby engaging and overlapping said exposed surfaces. FIG. 2 also shows a portafilter to container spacer 42, whose height and thickness can be adjusted so that different commercial portafilter baskets can be used.

Referring to FIGS. 1 and 4, a lower end of the chamber 38 includes one or more top attachment surfaces 62 upwardly exposed on an integrated indent, bulge, tab, slit, clip, or thread, forming a chamber attachment means via which to attach the water chamber 38 to the base 18. A top portion of the base 18 comprises one or more corresponding bottom attachment surfaces 64 downwardly exposed on an integrated indent, bulge, tab, slit, clip, or thread which engage and overlap with said water chamber top attachment surfaces 62 to prevent said chamber 38 and base 18 from separating vertically when a separation force is present during extraction. Alternatively, in a different embodiment, the water chamber 38 and base 18 could be integrally formed, as shown in FIG. 8 and designated as reference numeral 70 in the Figures.

Many modifications of the above embodiments will be apparent to those skilled in the art without departing from the scope of the present invention. For example, certain embodiments may provide any number of known leveraged jack/ratchet mechanisms, positioned between the piston 60 and the end tip of the arms 12, which allow the arms 12 to be shorter and moved up and down with more than one stroke to reduce the peak force required to be exerted by the user to move the arms 12 to produce 5-20 bar pressure.

It is envisaged that the chamber 38 and base 18 may be connectible via a quick-release mechanism, such as a twist bayonet-style attachment, to facilitate the dispensing of coffee and/or transport and cleaning of the removable components after extraction without the need to move the entire base 18 and arms 12 of the unit. In this case the piston 60 to end tip of the arms 12 is also easily detachable. In this embodiment it is envisaged that a separate air baffle (not shown in any figure) will be required to positive pressurize the top of the collector 20 and/or basket 14 and hence push the extracted puck 52, water and piston 60 down in the chamber, such that the piston 60 can be removed and the basket 14 and extracted puck 52 removed and cleaned.

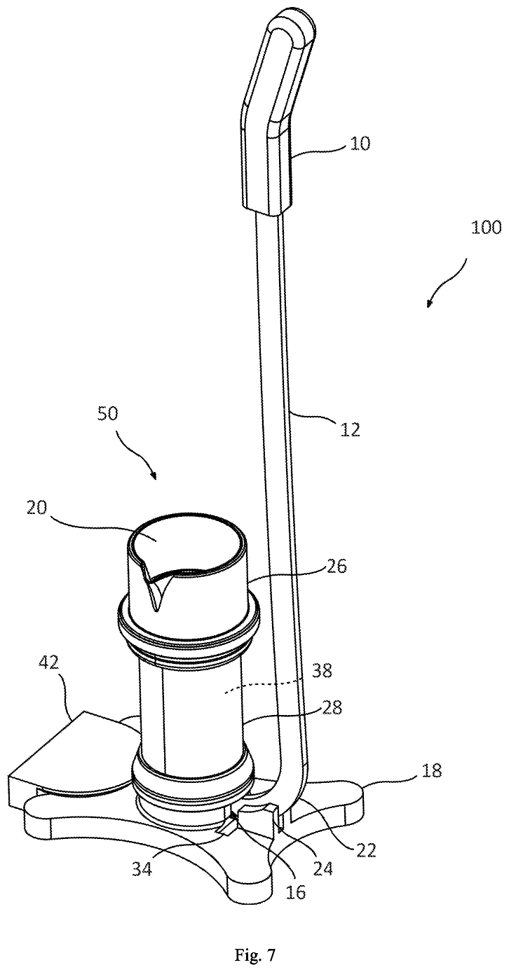

In FIG. 1, the handle grip 10 comprises a ball handle grip; FIG. 7 shows an alternative handle grip 10. Of course, other grips are within the scope of the present specification, including, for example, a T-shaped handle grip, or simply a top twisted and flattened arm 12 section.

In the single-arm embodiment shown in FIG. 7, there is provided a quick release hold down overhang section 42, under which one side of the base 18 slides to prevent the assembly 100 from tipping when the arm 12 is pulled down. In instances where the overhang section 42 is permanently mounted (e.g., to a bench surface), it is envisaged that the assembly 100 may be removed therefrom via a quick-release mechanism so that the assembly 100 can be tipped for dispensing of the extracted coffee.

Embodiments of the assembly 100 may also include, as shown in FIG. 11, an arm 12 hold down means, where an arm hold down section 92 is positioned around the base 18, and locked in place using chamber retainer pins 88, said pins can also retain chamber 38. A flexible pin retainer 90, prevents the pins from coming out.

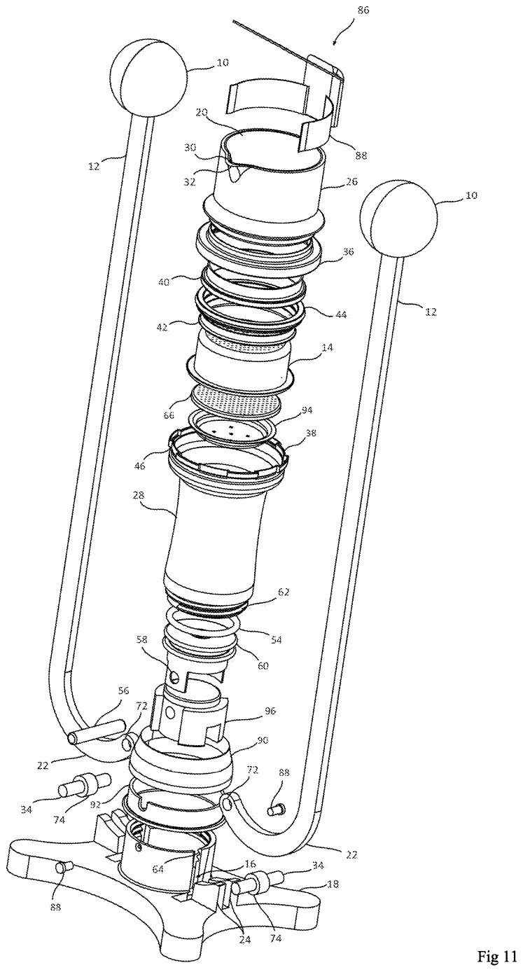

Embodiments of the assembly 100 may also include additional safety features, such as a safety excess pressure release mechanism built into said piston 60, and/or a safety splash screen cover 86 (see FIG. 10) which may be configured to clip to and over the collector 20 to protect against any splashing as the coffee is extracted. The cover 86 may be made from impact-resistant clear plastic such as polycarbonate. The clipping means 88 thereof may be formed from stainless steel. Other embodiments of the safety splash screen cover 86 can also include covers that substantially enclose the majority or entirety of the opening formed by the top edge of the collector 20.

The outer cylindrical wall of the collector 20 and the water chamber 38 may be provided with heat shielding means, such as respective silicon covers 26, 28 so that the user can safely grip and manipulate them while they contain hot liquid. These silicon covers 26, 28 may have long grooves on their inside surfaces, where these grooves run down the substantially cylindrical covers. The purpose of said grooves is to provide for extra heat insulation by providing an air gap and to provide for hot water channelling in the event of a burst water chamber 38.

Further, FIG. 11 shows a water separation disk 94 which can be used with any embodiments, whose purpose is to form a water chamber 38 separation barrier such that in use, a first volume of water is poured into a lower section of the water chamber 38, the separation disk 94 is positioned within the chamber 38 above the first volume of water and then a second volume of water is poured into the chamber 38 to fill an upper section thereof. The holes of said water separation disk 94 are small enough to prevent substantial mixing of the two volumes of water. During extraction, the piston 60 is forced upwardly and water in the lower section mixes with water in the upper section to provide a temperature or mineral gradient during extraction, whereby said volumes of water have different temperatures and/or different mineral solutes.

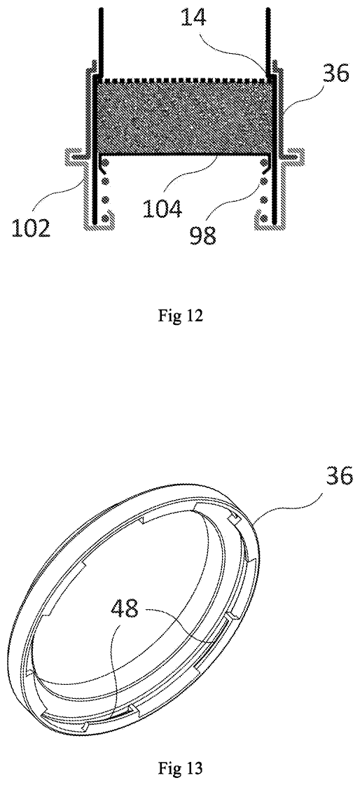

FIG. 12 also shows a transport retainer assembly that can be used with the coffee press assembly 100, said transport retainer assembly comprising a transport retainer section 102, with an attached retainer spring 98, with the other end of the spring attached to a transport retainer face 104 for use with the basket 14 to retain the coffee grounds during transport. Said transport retainer section 102 having matching locking means to engage the basket 14, collector 20 and/or separate locking section 36 such that the transport retainer assembly can be connected to and locked into the basket 14.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

In describing the invention, it will be understood that a number of techniques, means, structures, features, processes, and steps are disclosed. Each of these has individual benefits, and each can also be used in conjunction with one or more, or in some cases all, of the other disclosed techniques, means, structures, features, processes, and or steps. Accordingly, for the sake of brevity, this description will refrain from repeating every single possible combination of the individual said techniques, means, structures, processes, and steps in an unnecessary fashion. Nevertheless, the specification should be read with the understanding that such combinations are entirely within the scope of the invention.

### REFERENCE NUMERAL LIST

handle 10
arm/lever 12
basket with perforated base 14
side slot or port 16
base 18
collector 20
curved lower portion 22
arm alignments 24
silicon collector cover 26
silicon chamber cover 28
spout 30
heat shield spout cover 32
bearing shaft 34
separate locking section 36
chamber 38
flexible overflow seals 40
portafilter to container spacer 42
seal 44
bottom retaining surfaces of chamber 46
portafilter assembly top retaining surfaces 48
removable portafilter assembly 50 (comprising one or more of the basket 14,
collector 20 and separate locking section 36)
coffee puck 52
elastomeric sealing portion 54
cylindrical shaft 56
piston through hole 58
piston 60
top attachment surfaces of chamber 62
bottom attachment surfaces of base 64
puck retainer 66
bent angle portion of arms 68
integrally formed chamber and base 70
arm through hole 72
roller bearing/bushing 74
friction slide 76
bearing groove 78
diverter side wall 80
diverter long spout 82
linear bearing slide 84
safety splash screen cover 86
chamber retainer pin 88
flexible pin retainer 90
arm hold down section 92
water separation disk 94
arm locating retainer 96
spring retainer 98
manual coffee press assembly 100
transport retainer section 102
transport retainer face 104

1. A manual coffee press assembly comprising:
a hollow cylindrical chamber having a top opening via which water for brewing coffee can be poured into the chamber;
a basket having a perforated base onto which ground coffee beans can be loaded and tamped, wherein in use, the basket containing the tamped ground coffee beans is inverted and removably secured to the chamber to close the top opening thereof so that the ground coffee beans are held above water in the chamber;
a piston which, in use, forms an air-tight seal with the chamber so as to be drivable upwardly therethrough to force the water therein through the ground coffee beans in the basket so as to exit through the perforated base thereof as coffee; and
a collector from which the coffee exiting the perforated base can be dispensed.

2. The assembly of claim 1, further comprising a retaining disc securable to the basket for, in use, containing the tamped ground coffee beans in the inverted basket.

3. The assembly of claim 1, further comprising at least one lever that is manually operable in a first direction to drive the piston upwardly through the chamber.

4. The assembly of claim 3, wherein the at least one lever is manually operable in a second direction to drive the piston downwardly through the chamber.

5. The assembly of claim 4, further comprising a base from which the chamber extends upwardly, the base having locating means for guiding manual operation of the lever in the first and second directions.

6. The assembly of claim 1, claims, wherein the collector comprises a cylindrical wall surrounding and extending above the perforated base of the basket for capturing the coffee that exits therethrough.

7. The assembly of claim 1, further comprising a cover securable over the collector to contain coffee therein.

8. A method of making coffee using a manual coffee press assembly according to claim 1, comprising:
loading and tamping ground coffee beans into the basket;
pouring water into the chamber via the top opening thereof;
inverting the loaded basket and securing it to the chamber so as to close the top end thereof; and
driving the piston upwardly through the chamber to force the water upwardly through the ground coffee beans and out the perforated base of the basket as coffee for dispensing from the collector.

9. The method of claim 8, further including the step of inserting a retaining disc into the basket to hold the ground coffee beans in place.

10. The method of claim 8, wherein the assembly further comprises at least one lever that is manually operable in a first direction to drive the piston upwardly through the chamber and the step of driving the piston upwardly is performed by moving the at least one lever in the first direction.
